(19) United States
(12) Patent Application Publication
(10) Pub. No.: US 2021/0294310 A1
(43) Pub. Date: Sep. 23, 2021

(54) PROCESSING LINE COMPRISING PROCESSING MODULES FOR PERFORMING PROCESSING OPERATIONS ON A PRODUCT OR PART THEREOF, AND SIMULATED SMOKING DEVICE MANUFACTURING LINE

(71) Applicant: Sluis Cigar Machinery B.V., Kampen (NL)

(72) Inventor: Oscar SLURINK, Heino (NL)

(21) Appl. No.: 17/261,529

(22) PCT Filed: Jul. 19, 2019
(86) PCT No.: PCT/NL2019/050465

§ 371 Date: Jan. 19, 2021

(30) Foreign Application Priority Data
Jul. 19, 2018 (NL) 2021348

(51) Int. Cl. G05B 19/418; B65B 57/10; B65B 65/00

(52) U.S. Cl. CPC G05B 19/41865; G05B 2219/39106; B65B 65/003; B65B 57/10

(57) ABSTRACT

A processing line for performing processing operations on products or parts thereof to be conveyed in the processing line comprises a plurality of processing modules configured to perform different processing operations on the products. Each processing module comprises a transport receipt interface, a transport delivery interface, a transport device to move a product in a product carrier along a transport trajectory from the transport receipt interface to the transport delivery interface, and, along the trajectory, a first detector to detect presence or absence of a product in a product carrier, a processing station to perform a processing operation on a product, an evaluation station to evaluate the result of the processing operation on the product, a removal station to discharge the product from the processing module, and a controller configured to control the operations of the processing station, the evaluation station, and the removal station.

### FIELD OF THE INVENTION

The invention relates to the field of processing lines for performing processing operations on a product or part thereof to be conveyed in the processing line, and more specifically to a processing line comprising processing modules for performing processing operations on a product or part thereof. In particular, the invention may relate to a manufacturing line for simulated smoking devices, but the invention is not limited thereto.

### BACKGROUND OF THE INVENTION

In the automated manufacturing of a product, a plurality of processing steps may be taken to perform different processing operations in different processing stations on (parts of) the product to obtain a final, tested and approved product ready for sale. Processing operations may include assembly of parts, filling, marking, etc. A processing line may be designed to perform the different processing operations in a predetermined order, that is, having different processing stations arranged in a predetermined order along the processing line, depending on the design and structure of the product and parts thereof.

When one of the processing steps in a particular processing station cannot be performed, for example, because the processing station breaks down and needs repair, it may cause the whole processing line to be stopped until the particular processing station is functioning again, and the operation of the processing line can be resumed. This may result in a considerable loss of time and money.

Also, a processing in a particular processing station in a processing line may need to be changed, for example, because the design of the product is changed. A change of processing of a product may also incur the elimination of at least one processing step, and consequently the elimination of at least one processing station from a processing line. Also, a change of processing of a product may incur the addition of at least one processing step, and consequently the addition of at least one processing station to a processing line. Such changes may also cause the whole processing line to be taken out of operation for considerable time until a processing station has been converted, removed or added to perform a different processing step. In addition to that, a control of the processing line may need to be redesigned or reprogrammed to take into account the change of the processing station or processing operations, and changes may be necessary in one or more other processing stations as a consequence of a change of one or more processing stations or processing operations.

Furthermore, in a processing line wherein processing operations in multiple processing stations are performed, a defective processing operation in one station may lead to defective (sub)products being processed in subsequent processing stations. This may not only lead to defects of the subsequent processing stations, but also to defective products undergoing processing operations which cannot but lead to products being rejected. Thus, there is a risk for the operational safety of the processing line. Additionally, there is a risk of loss of resources.

Hence, there is a need for an improvement of a processing line, or at least for an alternative processing line, in which a product is manufactured in different subsequent processing operations in different processing stations, wherein the availability of the processing line in case of defects or changes of processing operations is high.

### SUMMARY OF THE INVENTION

It would be desirable to provide an improved or at least alternative processing line.

To better address this concern, in a first aspect of the invention a processing line for performing processing operations on products or parts thereof to be conveyed in the processing line is provided, wherein the processing line comprises a plurality of processing modules configured to perform different processing operations on the products or parts thereof, each processing module comprising:
a transport receipt interface to receive one of the products or parts thereof supplied to the processing module;
a transport delivery interface to deliver one of the products or parts thereof from the processing module;
a transport device to move one of the products or parts thereof in a product carrier along a transport trajectory from the transport receipt interface to the transport delivery interface, wherein the transport device comprises multiple product carriers;
a first detector arranged at the transport trajectory downstream of the transport receipt interface, wherein the first detector is configured to detect presence or absence of one of the products or parts thereof in one of the product carriers;
a processing station arranged at the transport trajectory downstream of the first detector, wherein the processing station is configured to perform a processing operation on one of the products or parts thereof;
an evaluation station arranged at the transport trajectory downstream of the processing station, wherein the evaluation station is configured to evaluate the result of the processing operation on the one of the products or parts thereof;
a removal station arranged at the transport trajectory downstream of the evaluation station, wherein the removal station is configured to remove one of the products or parts thereof from the corresponding product carrier to discharge the one of the products or parts thereof from the processing module, and to otherwise maintain the one of the products or parts thereof in the corresponding product carrier; and
a controller configured to control the operations of the processing station, the evaluation station, and the removal station.

Each processing module of the processing line is designed to operate as a self-contained unit to produce only products or parts thereof (which commonly may be referred to as “components”) that are approved for processing in a succeeding processing module. The processing modules transfer approved components from an upstream processing module to a next, downstream processing module via the transport delivery interface of the upstream processing module to the transport receipt interface of the downstream processing module.

A processing operation in a processing module neither depends on a possibly failed processing operation of any preceding processing module from which components are received at the transport receipt interface of the processing module, nor can result in a delivery of defective components to any succeeding processing module by the processing module from its transport delivery interface. In other words, the processing operation of one processing module does not affect, and is independent from, the processing operation of another processing module.

This provides a great flexibility and reliability in a processing line.

When assembling a processing line, one or more processing modules each performing a specific processing operation may be combined to constitute the processing line or a part thereof, by coupling a transport delivery interface of an upstream processing module to a transport receipt interface of a next, downstream processing module.

Changes in the processing line can be implemented relatively easy and quickly.

In a processing line, if a processing module, coupled between a first processing module and a second processing module, becomes defective, the defective processing module is simply and quickly decoupled from the first and second processing module, taken out of the processing line, and replaced by a similar processing module functioning properly, wherein the properly functioning processing module is coupled between the first processing module and the second processing module. In more detail, the exchange of the defective processing module by a similar processing module may be made by decoupling the transport receipt interface of the defective processing module from the transport delivery interface of the first processing module, decoupling the transport delivery interface of the defective processing module from the transport receipt interface of the second processing module, removing the defective processing module from the processing line, inserting the similar processing module in the processing line, coupling the transport receipt interface of the similar processing module to the transport delivery interface of the first processing module, and coupling the transport delivery interface of the similar processing module to the transport receipt interface of the second processing module. Thus, a downtime of the processing line is limited.

In case a new processing module is to be inserted into the processing line between a first processing module and a second processing module, wherein the transport delivery interface of the first processing module is coupled to the transport receipt interface of the second processing module, then first the transport delivery interface of the first processing module is decoupled from the transport receipt interface of the second processing module. Next, the new processing module is inserted into the processing line, wherein the transport delivery interface of the first processing module is coupled to the transport receipt interface of the new processing module, and wherein the transport delivery interface of the new processing module is coupled to the transport receipt interface of the second processing module. Hereby, a downtime of the processing line is quite limited, and the first and second processing modules, and any other processing modules, may remain unaffected in their operation.

In case an obsolete processing module, coupled between a first processing module and a second processing module, is to be removed from the processing line, the first the transport delivery interface of the first processing module is decoupled from the transport receipt interface of the obsolete processing module, and the transport delivery interface of the obsolete processing module is decoupled from the transport receipt interface of the second processing module. Then, the obsolete processing module is removed, and the transport delivery interface of the first processing module is coupled to the transport receipt interface of the second processing module. Hereby again, a downtime of the processing line is quite limited, and the first and second processing modules, and any other processing modules, may remain unaffected in their operation.

In these circumstances, a coupling between the transport delivery interface of the first processing module and the transport receipt interface of the second processing module may also be indirectly effected by leaving the obsolete processing module in the processing line, and only using the transport device thereof, while the operation of the processing station, the evaluation station, the removal station and possible other stations of the obsolete processing module is disabled.

In an embodiment of the processing line, the controller is configured to:
control the operation of the processing station and the evaluation station based on a detection made by the first detector, wherein, only if the first detector detects a presence of one of the products or parts thereof in one of the product carriers:
the processing station performs a processing operation on the one of the products or parts thereof in the one of the product carriers, and
the evaluation station performs an evaluation of the result of the processing operation on the one of the products or parts thereof in the one of the product carriers.

The first detector of a processing module allows for detecting which product carriers moved by the transport device actually carry a component, and which product carriers do not carry a component. Then, based on the detection by the first detector, the processing station of the processing module only needs to operate in the presence of a product carrier carrying a component, and can be left inactive in the presence of a product carrier which does not carry a component. Also, based on the detection by the first detector, the evaluation station of the processing module only needs to operate in the presence of a product carrier carrying a component which has been operated on in the upstream processing station of the processing module, and can be left inactive in the presence of a product carrier which does not carry a component, as indicated by the detection of the first detector. These controls minimize the operations of the processing station and the evaluation station of a processing module, which reduces wear, avoids unnecessary use of resources, and prolongs a mean time between failures, MTBF, of the processing station and the evaluation station.

In an embodiment of the processing line, the controller is configured to:
control the operation of the removal station based on an evaluation of one of the products or parts thereof made by the evaluation station, wherein, if the evaluation in the evaluation station indicates that the one of the products or parts thereof in one of the product carriers is to be rejected, the removal station removes the one of the products or parts thereof from the one of the product carriers.

The processing operation of the processing module being one of at least two different processing operations to be performed on a component, is performed in the processing station of the processing module, and next is evaluated in the evaluation station of the same processing module. If the evaluation of the component by the evaluation station of the processing module indicates that the processing operation in the processing station of the processing module has been performed correctly, i.e. that the component is not defective and is (to be) approved, the component will be delivered at the transport delivery interface of the processing module. However, if the evaluation of the component by the evaluation station of the processing module indicates that the processing operation in the processing station of the processing module has not been performed correctly, i.e. that the component is defective and is (to be) rejected, the removal station of the processing module will remove the component from the processing module, such as through a rejected component discharge to a rejected component container, and the component will not be delivered at the transport delivery interface of the processing module.

This implies that a particular processing module only receives components at its transport receipt interface which, in a preceding processing module, have been approved for the processing operation to be performed in the particular processing module.

In an embodiment of the processing line, at least one of the processing modules further comprises:
a second detector arranged at the transport trajectory upstream of the transport delivery interface, wherein the second detector is configured to detect a presence or absence of one of the products or parts thereof in one of the product carriers.

Advantageously, the second detector is used to perform a check whether any one of the processing station, the evaluation station, the removal station, and any further station upstream of the second detector has operated correctly to leave a component in the corresponding product carrier, if this should be the case, or to have removed a component from the corresponding product carrier, if this should be the case.

In an embodiment of the processing line comprising at least a processing module having a second detector, the controller is configured to:
control the operation of the transport device based on detections made by the first detector and the second detector, and the evaluation made in the evaluation station, wherein:
   if the first detector detects a presence of one of the products or parts thereof in one of the product carriers, and if the evaluation in the evaluation station indicates that the one of the products or parts thereof is to be rejected, and if the second detector detects a presence of the one of the products or parts thereof in the one of the product carriers, an operation of the transport device is stopped; or
   if the first detector detects a presence of one of the products or parts thereof in one of the product carriers, and if the evaluation in the evaluation station indicates that the one of the products or parts thereof is to be approved, and if the second detector detects an absence of the one of the products or parts thereof in the one of the product carriers, an operation of the transport device is stopped.

If the first detector detects a presence of a component in a product carrier, and if the evaluation in the evaluation station indicates that the component is to be rejected, the removal station should operate to remove the component from the corresponding product carrier. Hence, if this removal is successful, the second detector then should detect an absence of the component at the corresponding product carrier. However, if in these circumstances the second detector detects a presence of the rejected component in the product carrier, it is concluded that the removal station failed to remove the rejected component from the corresponding product carrier, and the rejected component is transported to the transport delivery interface. However, this is to be avoided, since then a downstream processing module would receive the rejected component which was rejected in the upstream processing module. To avoid this, the operation of the transport device of the processing module where the removal of the rejected component failed, is stopped. An alarm signal may be generated by the controller of the processing module. An operator may test and possibly adjust or repair the removal station, and release the processing module to resume normal operation if the removal station functions properly.

If the first detector detects a presence of a component in a product carrier, and if the evaluation in the evaluation station indicates that the component is to be approved, the removal station should not operate to remove the component from the corresponding product carrier. Hence, the second detector then should detect a presence of the approved component in the corresponding product carrier. However, if in these circumstances the second detector detects an absence of the approved component in the product carrier, it is concluded that the removal station removed the approved component from the corresponding product carrier, or that the approved component for some unknown reason was lost from the corresponding product carrier, so that the approved component is not transported to the transport delivery interface. However, this is to be avoided, since in this way an approved component is potentially lost. The removal station may malfunction. To avoid this, the operation of the transport device of the processing module where the undesired removal or inadvertent loss of the approved component occurred, is stopped. An alarm signal may be generated by the controller of the processing module. An operator may test and possibly adjust or repair the removal station, or find and fix another cause of the loss of the approved component from the corresponding product carrier, and release the processing module to resume normal operation if the removal station functions properly.

In an embodiment of the processing line, the removal station further is configured to remove one of the products or parts thereof from the corresponding product carrier to discharge the one of the products or parts thereof from the processing module for sampling the one of the products or parts thereof.

For a manual (human) monitoring of a correct operation of a processing module, approved components are sampled at regular intervals, for example at the control of the controller. The controller may be configured to control the removal station, even if the evaluation in the evaluation station indicates that the component is to be approved (and thus the removal station normally would not operate to remove the component from the corresponding product carrier), to operate to remove the component from the corresponding product carrier, this time for sampling purposes. Care should be taken not to mix rejected components with approved components, for example by discharging rejected components differently from discharging approved components.

In an embodiment of the processing line, at least one of the processing modules further comprises:
a sampling station arranged at the transport trajectory downstream of the evaluation station, wherein the sampling station is configured to remove one of the products or parts thereof from the corresponding product carrier to discharge the one of the products or parts thereof from the processing module for sampling the one of the products or parts thereof,
wherein the controller is further configured to control the sampling station.

In a processing module, the removal station may be used both for removal of rejected components and for removal (sampling) of approved components. However, in addition to the removal station, the processing module may comprise a dedicated sampling station. The sampling station is arranged downstream of the evaluation station to ensure that only approved components (for which the evaluation of the result of the processing operation in the upstream processing station indicates that the component is to be approved) will be sampled. The sampling station may be arranged upstream or downstream of the removal station, but upstream of the second detector, if present.

In an embodiment of the processing line, wherein the sampling station is upstream of the removal station, the controller is configured to:
control the operation of the sampling station based on an evaluation of one of the products or parts thereof made by the evaluation station, wherein, if the evaluation in the evaluation station indicates that the one of the products or parts thereof in one of the product carriers is to be rejected, the sampling station does not remove the one of the products or parts thereof from the one of the product carriers, to avoid a rejected component being sampled.

In an embodiment of the processing line, wherein the sampling station is downstream of the removal station, the controller is configured to:
control the operation of the sampling station based on an evaluation of one of the products or parts thereof made by the evaluation station, wherein, if the evaluation in the evaluation station indicates that the one of the products or parts thereof in one of the product carriers is to be approved, the sampling station is enabled to remove the one of the products or parts thereof from the one of the product carriers, to ensure that an approved component is sampled at the sampling time of the sampling station.

In an embodiment of the processing line comprising a processing module comprising a second detector and a sampling station, the controller is configured to:
control the operation of the transport device based on detections made by the first detector and the second detector, and the evaluation made in the evaluation station, wherein:
   if the first detector detects a presence of one of the products or parts thereof in one of the product carriers, and if the evaluation in the evaluation station indicates that the one of the products or parts thereof is to be rejected or the sampling station is controlled to sample the one of the products or parts thereof, and if the second detector detects a presence of the one of the products or parts thereof in the one of the product carriers, an operation of the transport device is stopped; or
   if the first detector detects a presence of one of the products or parts thereof in one of the product carriers, and if the evaluation in the evaluation station indicates that the one of the products or parts thereof is to be approved or the sampling station is controlled not to sample the one of the products or parts thereof, and if the second detector detects an absence of the one of the products or parts thereof in the one of the product carriers, an operation of the transport device is stopped.

If the first detector detects a presence of a component in a product carrier, and if the evaluation in the evaluation station indicates that the component is to be rejected, or the sampling station is controlled to sample the one of the components, the removal station should operate to remove the component from the corresponding product carrier, or the sampling station should operate to remove the component from the corresponding product carrier. Hence, if the removal of the removal station or the sampling station is successful, the second detector then should detect an absence of the rejected or sampled component at the corresponding product carrier. However, if in these circumstances the second detector detects a presence of the rejected component or the component to be sampled in the product carrier, it is concluded that the removal station or the sampling station failed to remove the rejected component or component to be sampled from the corresponding product carrier, and the rejected component or component to be sampled is transported to the transport delivery interface. However, this is to be avoided, since then a downstream processing module could receive a rejected component which was rejected in the upstream processing module. To avoid this, the operation of the transport device of the processing module where the removal of the rejected component or the sampling of the component failed, is stopped. An alarm signal may be generated by the controller of the processing module. An operator may test and possibly adjust or repair the removal station or the sampling station, and release the processing module to resume normal operation if the removal station or the sampling station functions properly.

If the first detector detects a presence of a component in a product carrier, and if the evaluation in the evaluation station indicates that the component is to be approved, or the sampling station is controlled not to sample the one of the components, the removal station should not operate to remove the component from the corresponding product carrier, and the sampling station should not operate to remove the component from the corresponding product carrier. Hence, the second detector then should detect a presence of the approved component in the corresponding product carrier. However, if in these circumstances the second detector detects an absence of the approved component in the product carrier, it is concluded that the removal station and/or the sampling station removed the approved component from the corresponding product carrier, or that the approved component for some unknown reason was lost from the corresponding product carrier, so that the approved component is not transported to the transport delivery interface. However, this is to be avoided, since in this way an approved component is potentially lost. The removal station and/or the sampling station may malfunction. To avoid this, the operation of the transport device of the processing module where the undesired removal of the approved component occurred, is stopped. An alarm signal may be generated by the controller of the processing module. An operator may test and possibly adjust or repair the removal station and/or the sampling station, or find and fix another cause of the loss of the approved component from the corresponding product carrier, and release the processing module to resume normal operation if the removal station and the sampling station function properly.

In an embodiment of the processing line, the controller further is configured to communicate with a further controller of a further processing module to control at least the transport device of the further processing module.

In case the second detector detects a presence of a component in a product carrier whereas an absence of the component should be expected, or in case the second detector detects an absence of a component in a product carrier whereas a presence of the component should be expected, the transport device of the corresponding processing module is stopped. To avoid at least upstream processing modules to deliver components to the processing module with stopped transport device (since these components cannot be processed there), the transport devices of the upstream processing modules are stopped also, by the controller of the processing module with stopped transport device communicating with the controllers of the upstream processing modules to stop their transport devices. Further, to avoid downstream processing modules to operate without receiving components from the processing module with stopped transport device (since there are no components to be processed there), the transport devices of the downstream processing modules are stopped also, by the controller of the processing module with stopped transport device communicating with the controllers of the downstream processing modules to stop their transport devices.

The transport receipt interface of a particular processing module is adapted to interact with the transport delivery interface of a preceding processing module, for transfer of components from the preceding processing module to the particular processing module. Also, the transport delivery interface of the particular processing module is adapted to interact with the mechanical transport receipt interface of a succeeding processing module, for transfer of components from the particular processing module to the succeeding processing module.

Accordingly, in an embodiment the processing modules can function in a processing line in different following orders, simply by reversing the order of the processing modules. Since for each processing module the transport receipt interface of the processing module is adapted to interact with the transport delivery interface of a preceding processing module, and the transport delivery interface of the particular processing module is adapted to interact with the transport receipt interface of a succeeding processing module, a smooth transfer of components from one processing module to a next processing module remains ensured. The product flow and processing in each one of the processing modules themselves are not affected by this reversal.

In an embodiment of the processing line, the transport receipt interface of at least one of the processing modules is configured to be directly coupled to a transport delivery interface of a preceding processing module. In a further embodiment of the processing line, the transport delivery interface of at least one of the processing modules is configured to be directly coupled to a transport receipt interface of a succeeding processing module.

The processing modules provide the advantageous opportunity to construct a processing line for performing a number of processing operations by coupling a number of processing modules, wherein, for any pair of processing modules coupled to each other, a transport delivery interface of an upstream, preceding processing module may be directly coupled to a transport receipt interface of a downstream, succeeding processing module, whereby a component may be transferred from the upstream processing module to the downstream processing module.

Preferably, but not necessarily, the transport receipt interfaces and the transport delivery interfaces of the processing modules are standardized, such that any transport receipt interface of any processing module may be coupled to any transport delivery interface of any other processing module. An advantage of this feature is that an order or number of processing modules in a processing line may be easily changed by combining and rearranging the processing modules in the processing line.

It is noted here that components are transferred from a transport delivery interface of a processing module to a transport receipt interface of a downstream processing module. In some embodiments, also products carriers are transferred from a transport delivery interface of a processing module to a transport receipt interface of a downstream processing module, wherein the product carriers may carry a component if the component was approved and not sampled in the upstream processing module.

In a second aspect, the present invention provides a simulated smoking device manufacturing line for performing processing operations on components of simulated smoking devices to be conveyed in the manufacturing line, wherein the simulated smoking device manufacturing line comprises a plurality of processing modules configured to perform different processing operations on the components, each processing module comprising:
a transport receipt interface to receive one of the components supplied to the processing module;
a transport delivery interface to deliver one of the components from the processing module;
a transport device to move one of the components in a product carrier along a transport trajectory from the transport receipt interface to the transport delivery interface, wherein the transport device comprises multiple product carriers;
a first detector arranged at the transport trajectory downstream of the transport receipt interface, wherein the first detector is configured to detect presence or absence of one of the components in one of the product carriers;
a processing station arranged at the transport trajectory downstream of the first detector, wherein the processing station is configured to perform a processing operation on at least one of the components;
an evaluation station arranged at the transport trajectory downstream of the processing station, wherein the evaluation station is configured to evaluate the result of the processing operation on the at least one of the components;
a removal station arranged at the transport trajectory downstream of the evaluation station, wherein the removal station is configured to remove one of the components from the corresponding product carrier to discharge the one of the components from the processing module, and to otherwise maintain the one of the components in the corresponding product carrier; and
a controller configured to control the operations of the processing station, the evaluation station, and the removal station.

These and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 depicts a schematic block diagram of an embodiment of a processing module for use in a processing line according to the present invention.

FIG. 2 depicts a schematic block diagram of another embodiment of a processing module for use in a processing line according to the present invention.

FIG. 3 depicts a schematic block diagram of still another embodiment of a processing module for use in a processing line according to the present invention.

FIG. 4 depicts a schematic block diagram of yet another embodiment of a processing module for use in a processing line according to the present invention.

FIG. 5 depicts a schematic block diagram of a processing line according to the present invention.

FIG. 6 depicts a schematic block diagram of a processing line according to the present invention, and illustrates a replacement of a processing module in the processing line, a removal of a processing module from the processing line, or an insertion of a processing module into the processing line.

FIG. 7 depicts in perspective view two processing modules being part of a processing line for manufacturing simulated smoking devices.

FIG. 8 depicts a plan view of the processing modules of FIG. 7.

FIG. 9 depicts a schematic perspective view of parts of a simulated smoking device to illustrate processing operations on components thereof by the processing modules of FIGS. 7 and 8.

### DETAILED DESCRIPTION OF EMBODIMENTS

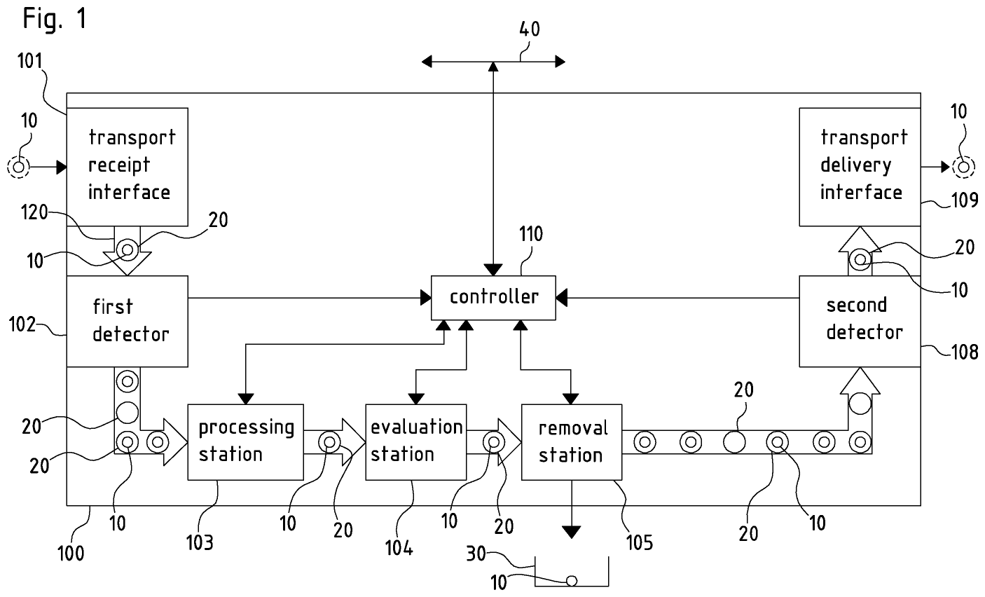

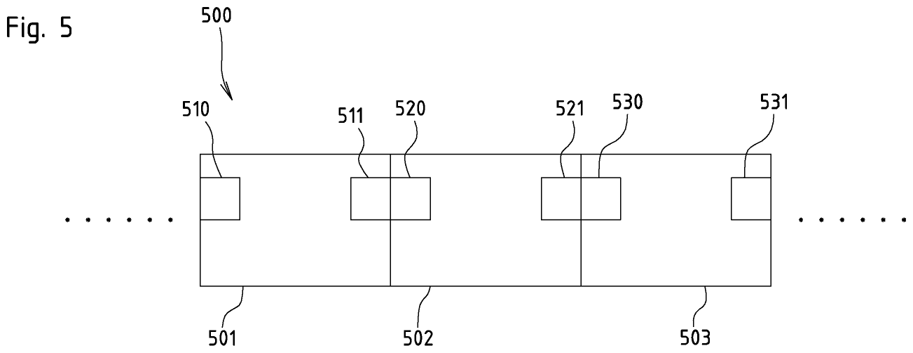

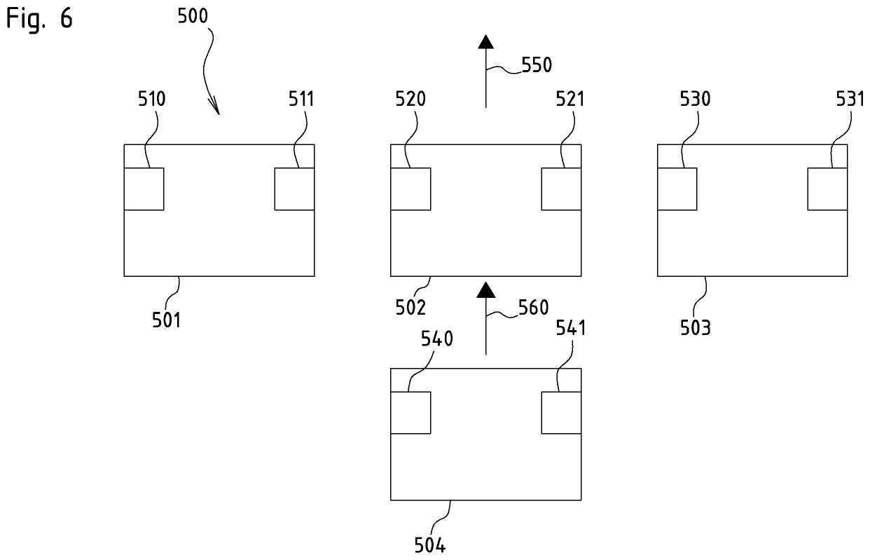

FIG. 1 depicts a schematic block diagram of a processing module 100 for use in a processing line for performing processing operations on products or parts thereof (hereinafter commonly also referred to as “components” 10 for brevity) to be conveyed in the processing line, wherein the processing line comprises a plurality of processing modules configured to perform different processing operations on the components 10, as will be explained below in more detail by reference to FIGS. 5 and 6.

In FIG. 1, each processing module 100 comprises a transport receipt interface 101 to receive one of the components 10 supplied to the processing module 100, and a transport delivery interface 109 to deliver one of the components 10 from the processing module 100. The processing module 100 further comprises a transport device 120, symbolized by broad arrows, to move one of the components 10 in a product carrier 20 along a transport trajectory from the transport receipt interface 101 to the transport delivery interface 109. The transport device 120 comprises multiple product carriers 20. An example of a transport device 120 is a conveyor, such as an overhead conveyor or a belt conveyor, comprising the product carriers 20. The transport device 120 may also comprise moving members, such as rotating disks provided with recesses at their circumference, and being movable along supporting rims, the recesses in combination with the rims forming product carriers 20.

Also product carriers 20 may be received at the transport receipt interface 101, as indicated by a dashed circle, either carrying a component 10 or not carrying a component 10, depending on a processing in a preceding processing module. Similarly, also product carriers 20 may be delivered at the transport delivery interface 109, as indicated by a dashed circle, either carrying a component 10 or not carrying a component 10, depending on the processing module 100.

Thus, a product carrier 20 may be a location on a transport device 120, or a product carrier 20 may be a separate element conveyed by the transport device 120.

The processing module 100 further comprises a first detector 102 arranged at the transport trajectory downstream of the transport receipt interface 101. The first detector 102 is configured to detect presence or absence of one of the components 10 in one of the product carriers 20. Examples of first detectors 102 are optical sensors, proximity sensors, and mechanical sensors, to detect a presence or absence of a component 10 in a product carrier 20 moving along the transport trajectory of the processing module 100.

The processing module 100 further comprises a processing station 103 arranged at the transport trajectory downstream of the first detector 102. The processing station 103 is configured to perform a processing operation on one of the components. Examples of processing operations are assembling components, labeling, printing an identification, and filling.

The processing module 100 further comprises an evaluation station 104 arranged at the transport trajectory downstream of the processing station 103. The evaluation station 104 is configured to evaluate the result of the processing operation performed in the processing station 103 on the one of the components 10. Examples of evaluation operations are image recognition and analysis, measuring a physical quantity such as mass, measuring an electrical quantity such as resistance, and measuring a chemical composition.

The processing module 100 further comprises a removal station 105 arranged at the transport trajectory downstream of the evaluation station 104. The removal station 105 is configured to remove one of the components 10 from the corresponding product carrier 20 to discharge the one of the components 10, in particular defective or rejected components 10, from the processing module 100, such as into a container 30 as indicated by an arrow, and to otherwise maintain the one of the components 10, in particular non-defective or approved components 10, in the corresponding product carrier 20. Examples of effecting a removal of a component 10 are gripping, pushing, pulling, tipping, suction and blowing.

The processing module 100 further comprises a controller 110 configured to control the operations of the processing station 103, the evaluation station 104, and the removal station 105. The controller 110 may comprise one or more control units interacting with each other to perform different control tasks.

The processing module 100 may further comprise a second detector 108 arranged at the transport trajectory upstream of the transport delivery interface 109. The second detector 108 is configured to detect a presence or absence of one of the components 10 in one of the product carriers 20. Similar to the first detector 102, examples of second detectors 108 are optical sensors, proximity sensors, and mechanical sensors, to detect a presence or absence of a component 10 in a product carrier 20 moving along the transport trajectory of the processing module 100.

Single-line arrows indicate lines of control between the controller 110 and the first detector 102, the processing station 103, the evaluation station 104, the removal station 105, and the optional second detector 108. The controller 110 is configured to receive detection signals from the first detector 102, the detection signals indicating a presence or absence of one of the components 10 in a corresponding product carrier 20 at the first detector 102. If the second detector 108 is included in the processing module 100, the controller 110 is further configured to receive detection signals from the second detector 108, the detection signals indicating a presence or absence of one of the components 10 in a corresponding product carrier 20 at the second detector 109. The controller 110 is further configured to control the processing station 103 to perform its processing operation on one of the components 10, to control the evaluation station 104 to perform its evaluation on one of the components 10, and to control the removal station 105 to remove one of the components 10 from the corresponding product carrier 20, and to otherwise maintain the one of the products in the corresponding product carrier 20. The processing station 103, evaluation 104 and removal station 105 may return status signals to the controller 110.

The controller 110 may further communicate with one or more controllers of other processing modules included in the processing line, as indicated by double arrow 40.

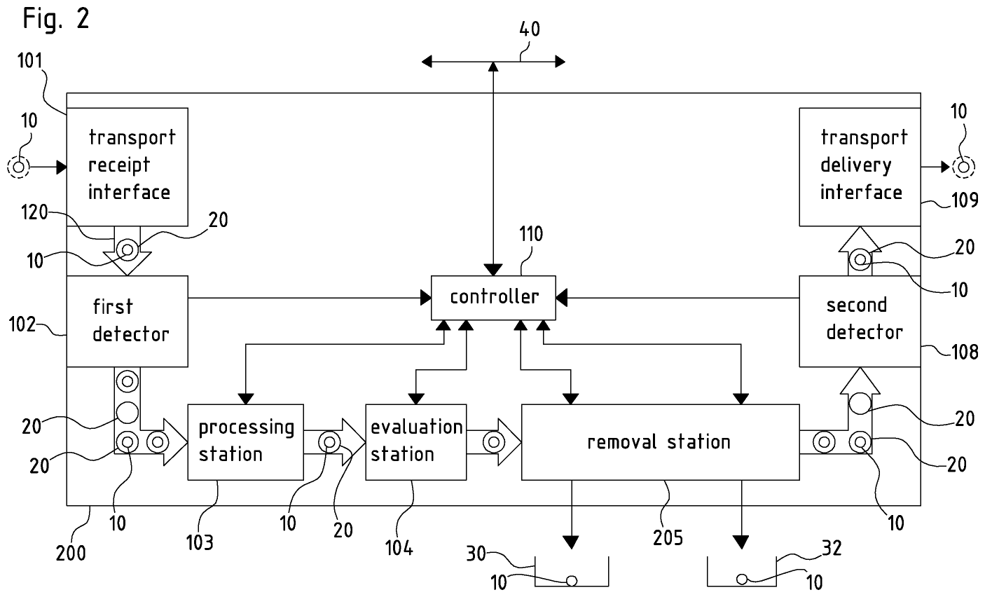

FIG. 2 depicts a schematic block diagram of a processing module 200 for use in a processing line for performing processing operations on components 10 to be conveyed in the processing line, wherein the processing line comprises a plurality of processing modules configured to perform different processing operations on the components 10, as will be explained below in more detail by reference to FIGS. 5 and 6.

In FIG. 2, the processing module 200 generally has the same structure and operation as the processing module 100, and a description of the parts of the processing module 200 which are similar to parts of the processing module 100, as indicated by their similar reference signs, is omitted here for this reason.

As in processing module 100, also in processing module 200 the second detector 108 is optional.

The processing module 200 comprises a removal station 205 having two different discharges. A first discharge is configured to discharge defective/rejected components from the processing module 200, such as into container 30 as indicated by an arrow. A second discharge is configured to discharge non-defective, approved components which are sampled, from the processing module 200, such as into container 32 as indicated by an arrow. Components that are non-defective/approved, and which are not sampled, are transported by the transport device 120 towards the transport delivery interface 109, along second detector 108, if present in the processing module 200.

The removal station 205 is controlled by the controller 110 to select the first discharge or the second discharge, depending on removal of a defective/rejected component or removal of a sampled component, respectively.

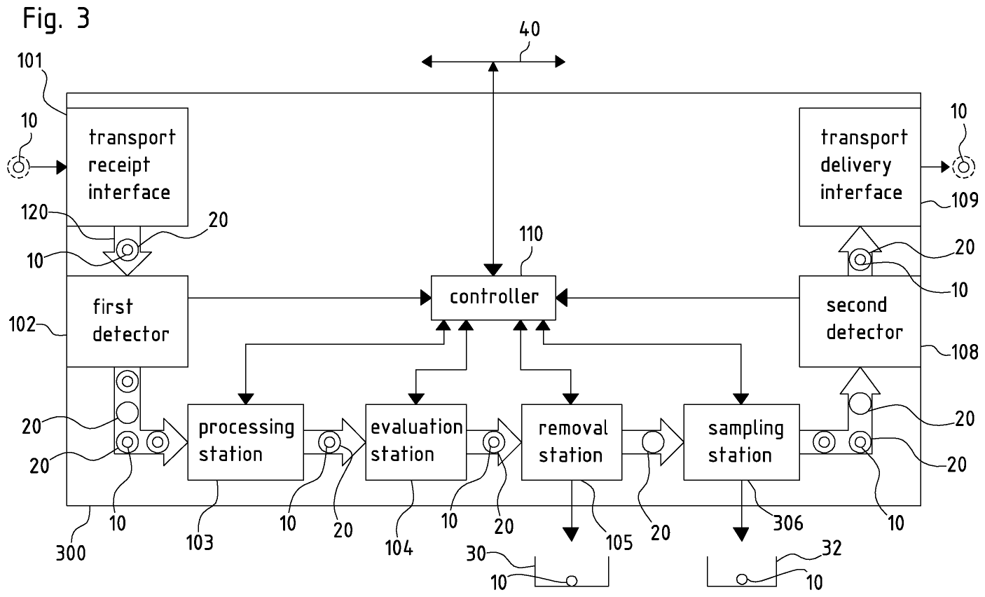

FIG. 3 depicts a schematic block diagram of a processing module 300 for use in a processing line for performing processing operations on components 10 to be conveyed in the processing line, wherein the processing line comprises a plurality of processing modules configured to perform different processing operations on the components 10, as will be explained below in more detail by reference to FIGS. 5 and 6.

In FIG. 3, the processing module 300 generally has the same structure and operation as the processing module 100, and a description of the parts of the processing module 300 which are similar to parts of the processing module 100, as indicated by their similar reference signs, is omitted here for this reason.

As in processing modules 100 and 200, also in processing module 300 the second detector 108 is optional.

The processing module 300 comprises a sampling station 306 arranged at the transport trajectory downstream of the evaluation station 104, and downstream of the removal station 105. The sampling station 306 is configured to remove one of the components 10 from the corresponding product carrier 20 to discharge the one of the components 10, in particular a sampled component 10, from the processing module 100, such as into a holder or a container 32, as indicated by an arrow, or to maintain the one of the components 10 in the corresponding product carrier 20. The controller 110 is configured to control the sampling station 306. Components which are not sampled, are transported by the transport device 120 towards the transport delivery interface 109, along second detector 108, if present in the processing module 300.

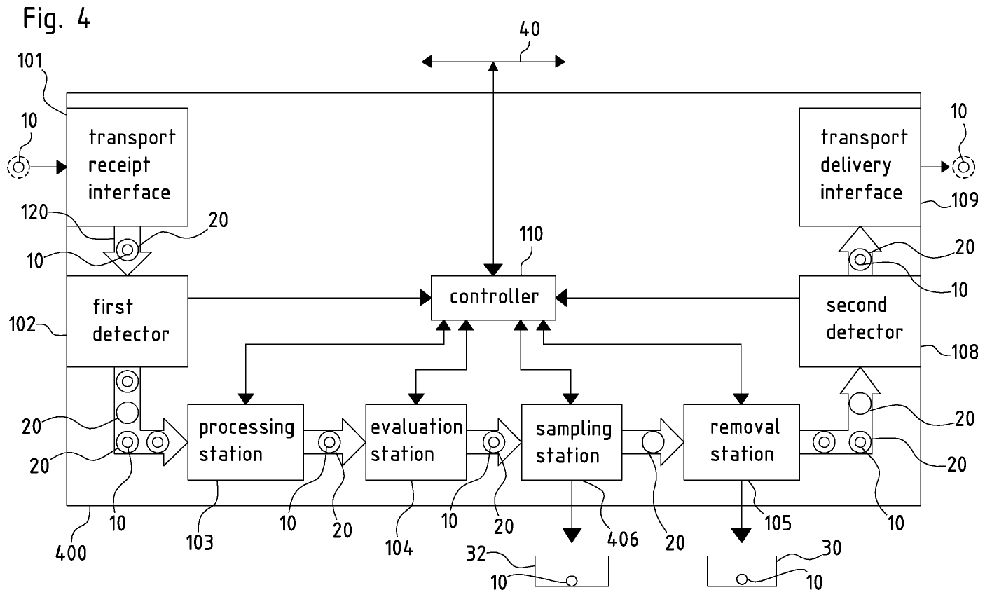

FIG. 4 depicts a schematic block diagram of a processing module 400 for use in a processing line for performing processing operations on components 10 to be conveyed in the processing line, wherein the processing line comprises a plurality of processing modules configured to perform different processing operations on the components 10, as will be explained below in more detail by reference to FIGS. 5 and 6.

In FIG. 4, the processing module 400 generally has the same structure and operation as the processing module 300, and a description of the parts of the processing module 400 which are similar to parts of the processing module 300, as indicated by their similar reference signs, is omitted here for this reason.

As in processing modules 100, 200 and 300, also in processing module 400 the second detector 108 is optional.

The processing module 400 comprises a sampling station 406 arranged at the transport trajectory downstream of the evaluation station 104, and upstream of the removal station 105. The sampling station 406 is configured to remove one of the components 10 from the corresponding product carrier 20 to discharge the one of the components 10, in particular a sampled component 10, from the processing module 100, such as into a holder or a container 32, as indicated by an arrow, or to maintain the one of the components 10 in the corresponding product carrier 20. The controller 110 is configured to control the sampling station 406. Components which are not sampled, are transported by the transport device 120 towards the transport delivery interface 109, along removal station 105 and along second detector 108, if present in the processing module 400.

In operation of a processing module 100, 200, 300, 400, the first detector 102 of a processing module 100, 200, 300, 400 allows for detecting which product carriers 20 moved by the transport device 120 actually carry a component 10, and which product carriers 20 do not carry a component 10. Then, based on the detection by the first detector 102, and as controlled by the controller 110 storing detection results of the first detector 102, the processing station 103 of the processing module 100, 200, 300, 400 only needs to operate in the presence of a product carrier 20 carrying a component 10, and can be left inactive in the presence of a product carrier 20 which does not carry a component 10. Also, based on the detection by the first detector 102, and as controlled by the controller 110 storing detection results of the first detector 102, the evaluation station 104 of the processing module 100, 200, 300, 400 only needs to operate in the presence of a product carrier 20 carrying a component 10 which has been operated on in the upstream processing station 103 of the processing module 100, 200, 300, 400, and can be left inactive in the presence of a product carrier 20 which does not carry a component 10, as indicated by the detection of the first detector 102.

If the evaluation of the component 10 by the evaluation station 104 of the processing module 100, 200, 300, 400 indicates that the processing operation in the processing station 103 has been performed correctly, i.e. that the component 10 is not defective and is (to be) approved, the component 10 may be delivered at the transport delivery interface 109 of the processing module 100, 200, 300, 400 by the transport device 120. If a possibility of sampling one of the components 10 is foreseen, as in removal station 205 of processing module 200, or in sampling station 306 or 406 of processing modules 300, 400, respectively, the non—defective/approved component 10 may be sampled before it reaches the transport delivery interface 109. However, if the evaluation of the component 10 by the evaluation station 104 of the processing module 100, 200, 300, 400 indicates that the processing operation in the processing station 103 has not been performed correctly, i.e. that the component is defective and is (to be) rejected, the removal station 105 (in processing modules 100, 300, 400) or 205 (in processing module 200) will remove the component 10 from the processing module, such as through a rejected component discharge to a rejected component container 30, and the component 10 will not be delivered at the transport delivery interface 109 of the processing module 100, 200, 300, 400.

As explained above, the second detector 108 is optional in the processing modules 100, 200, 300, 400. If the second detector 108 is present, then an operation of the processing module may be as follows.

If the first detector 102 detects a presence of a component 10 in a product carrier 20, and if the evaluation in the evaluation station 104 indicates that the component 10 is to be rejected, or the removal station 205 or (if present) the sampling station 306, 406 is controlled to sample the one of the components, the removal station 105, 205 should operate to remove the component 10 from the corresponding product carrier 20, or the sampling station 306, 406 should operate to remove the component 10 from the corresponding product carrier 20.

Hence, if the removal of the removal station 105, 205 or the sampling station 306, 406 is successful, the second detector 108 then should detect an absence of the rejected or sampled component 10 at the corresponding product carrier 20. However, if in these circumstances the second detector 108 detects a presence of the rejected component 10 or the component 10 to be sampled in the product carrier 20, it is determined by the controller 110 that the removal station 105, 205 or the sampling station 306, 406 failed to remove the rejected component 10 or component 10 to be sampled from the corresponding product carrier 20, and the rejected component 10 or component 10 to be sampled is transported to the transport delivery interface 109. However, this is to be avoided, since then a downstream processing module could receive a rejected component 10 which was rejected in the upstream processing module 100, 200, 300, 400. To avoid this, the operation of the transport device 120 of the processing module 100, 200, 300, 400 where the removal of the rejected component 10 or the sampling of the component 10 failed, is stopped. An alarm signal may be generated by the controller 110 of the processing module 100, 200, 300, 400. An operator may test and possibly adjust or repair the removal station 105, 205 or the sampling station 306, 406, and release the processing module 100, 200, 300, 400 to resume normal operation if the removal station 105, 205 or the sampling station 30, 406 functions properly.

If the first detector 102 detects a presence of a component 10 in a product carrier 20, and if the evaluation in the evaluation station 104 indicates that the component 10 is to be approved, or the removal station 205 or (if present) the sampling station 306, 406 is controlled not to sample the one of the components 10, the removal station 105, 205 should not operate to remove the component 10 from the corresponding product carrier 20, and the sampling station 306, 406 should not operate to remove the component 10 from the corresponding product carrier 20. Hence, the second detector 108 then should detect a presence of the approved component 10 in the corresponding product carrier 20. However, if in these circumstances the second detector 108 detects an absence of the approved component 10 in the product carrier 20, it is determined by the controller 110 that the removal station 105, 205 and/or the sampling station 306, 406 removed the approved component 10 from the corresponding product carrier 20, or that the approved component 10 for some unknown reason was lost from the corresponding product carrier 20, so that the approved component 10 is not transported to the transport delivery interface 109. However, this is to be avoided, since in this way an approved component 10 is potentially lost. The removal station 105, 205 and/or the sampling station 306, 406 may malfunction. To avoid this, the operation of the transport device 120 of the processing module 100, 200, 300, 400 where the undesired removal of the approved component 10 occurred, is stopped. An alarm signal may be generated by the controller 110 of the processing module 100, 200, 300, 400. An operator may test and possibly adjust or repair the removal station 105, 205 and/or the sampling station 306, 406, or find and fix another cause of the loss of the approved component 10 from the corresponding product carrier 20, and release the processing module 100, 200, 300, 400 to resume normal operation if the removal station 105, 205 and the sampling station 306, 406 function properly.

Summarizing the above, in case the second detector 108 detects a presence of a component 10 in a product carrier 20 whereas an absence of the component 10 should be expected, or in case the second detector 108 detects an absence of a component 10 in a product carrier 20 whereas a presence of the component 10 should be expected, the transport device 120 of the corresponding processing module 100, 200, 300, 400 is stopped. To avoid at least upstream processing modules 100, 200, 300, 400 to deliver components 10 to the processing module 100, 200, 300, 400 with stopped transport device 120 (since these components 10 cannot be processed there), the transport devices 120 of the upstream processing modules 100, 200, 300, 400 are stopped also, by the controller 110 of the processing module 100, 200, 300, 400 with stopped transport device 120 communicating (as indicated by double arrow 40) with the controllers 110 of the upstream processing modules 100, 200, 300, 400 to stop their transport devices 120 also. Further, to avoid downstream processing modules 100, 200, 300, 400 to operate without receiving components 10 from the processing module 100, 200, 300, 400 with stopped transport device 120 (since there are no components 10 to be processed there), the transport devices 120 of the downstream processing modules 100, 200, 300, 400 are stopped also, by the controller 110 of the processing module 100, 200, 300, 400 with stopped transport device 120 communicating (as indicated by double arrow 40) with the controllers 110 of the downstream processing modules 100, 200, 300, 400 to stop their transport devices.

FIG. 5 depicts a schematic block diagram of a processing line 500 or a part thereof. The processing line 500 comprises first, second and third processing modules 501, 502 and 503, wherein second processing module 502 is arranged downstream of first processing module 501, and third processing module 503 is arranged downstream of second processing module 502. Other processing modules may be arranged upstream of first processing module 501, or downstream of third processing module 503, as indicated by dotted lines. Each one of the first, second and third processing modules 501, 502, 503 may be designed as one of processing modules 100, 200, 300, 400 as described above and illustrated in FIGS. 1 to 4, respectively.

First processing module 501 comprises a first transport receipt interface 510 and a first transport delivery interface 511. Second processing module 502 comprises a second transport receipt interface 520 and a second transport delivery interface 521. Third processing module 503 comprises a third transport receipt interface 530 and a third transport delivery interface 531.

Approved components, possibly carried by product carriers, are transferred to first transport receipt interface 510, and processed in first processing module 501. The components approved by the evaluation station of the first processing module 501, and not sampled, are transferred, possibly carried by product carriers, from first transport delivery interface 511 to second transport receipt interface 520, and processed in second processing module 502. The components approved by the evaluation station of the second processing module 502, and not sampled, are transferred, possibly carried by product carriers, from second transport delivery interface 521 to third transport receipt interface 530, and processed in third processing module 503. The components approved by the evaluation station of the third processing module 503, and not sampled, are transferred, possibly carried by product carriers, from third transport delivery interface 531 for further processing.

The second or third transport receipt interface 520, 530 of at least one of the second and third processing modules 502, 503 may be configured to be directly coupled to a first or second transport delivery interface 511, 521 of a preceding first or second processing module 501, 502. The first or second transport delivery interface 511, 521 of at least one of the first and second processing modules 501, 502 may be configured to be directly coupled to a second or third transport receipt interface 520, 530 of a succeeding second or third processing module 502, 503.

In general, the first, second and third processing modules 501, 502, 503 construct (a part of) a processing line 500 for performing a number of processing operations by coupling the first, second and third processing modules 501, 502, 503.

Preferably, but not necessarily, the first, second and third transport receipt interfaces 510, 520, 530 and the first, second and third transport delivery interfaces 511, 521, 531 of the first, second and third processing modules 501, 502, 503 are standardized, such that any transport receipt interface of any processing module may be coupled to any transport delivery interface of any other processing module. An advantage of this feature is that an order or number of processing modules in a processing line may be easily changed by combining and rearranging the processing modules in the processing line.

FIG. 6 schematically illustrates a removal of a second processing module 502 from a processing line 500, assuming that the processing operation provided by the second processing module 502 is to be dispensed with. Starting from an arrangement illustrated in FIG. 5, the first transport delivery interface 511 and the second transport receipt interface 520 are decoupled. Also, the second transport delivery interface 521 and the third transport receipt interface 530 are decoupled. As indicated by arrow 550, the second processing module 502 then is removed from the processing line 500. Next, the first transport delivery interface 511 is coupled to the third transport receipt interface 530 to enable transfer of components from the first processing module 501 to the third processing module 503, and an operation of the processing line 500 can be resumed.

FIG. 6 also schematically illustrates a replacement of a second processing module 502 by a fourth processing module 504 having fourth transport receipt interface 540 and fourth transport delivery interface 541, assuming that the processing operation provided by the second processing module 502 is to be replaced by a processing operation provided by the fourth processing module 504. An insertion of the fourth processing module 504 at another location in the processing line 500, for example between the first processing module 501 and the second processing module 502 or between the second processing module 502 and the third processing module 503, comprises partly similar steps.

For the replacement, starting from an arrangement illustrated in FIG. 5, the first transport delivery interface 511 and the second transport receipt interface 520 are decoupled. Also, the second transport delivery interface 521 and the third transport receipt interface 530 are decoupled. As indicated by arrow 550, the second processing module 502 then is removed from the processing line 500. Next, as indicated by arrow 560, the fourth processing module 504 is inserted into the processing line 500, the first transport delivery interface 511 is coupled to the fourth transport receipt interface 540 to enable transfer of components from the first processing module 501 to the fourth processing module 504, the fourth transport delivery interface 541 is coupled to the third transport receipt interface 530 to enable transfer of components from the fourth processing module 504 to the third processing module 503, and an operation of the processing line 500 can be resumed.

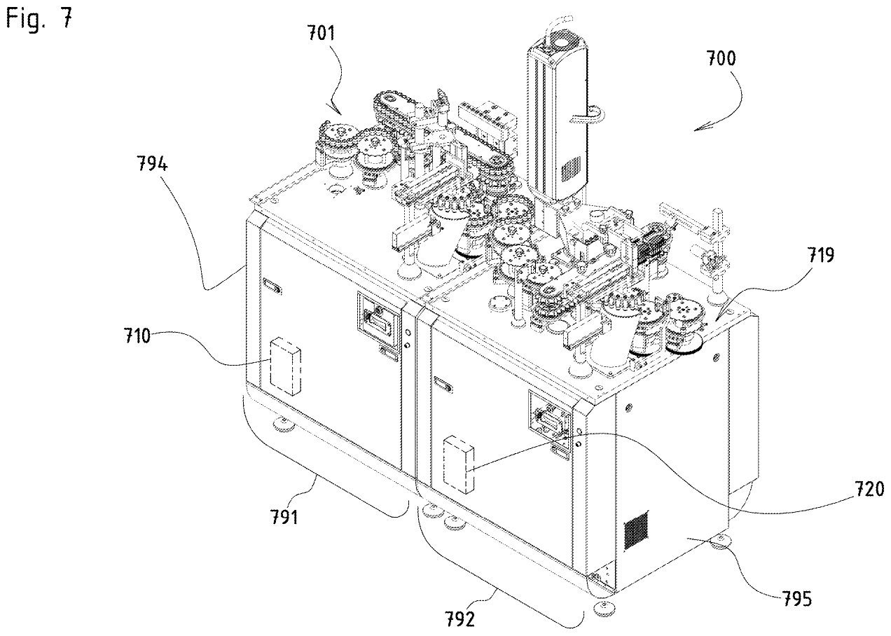

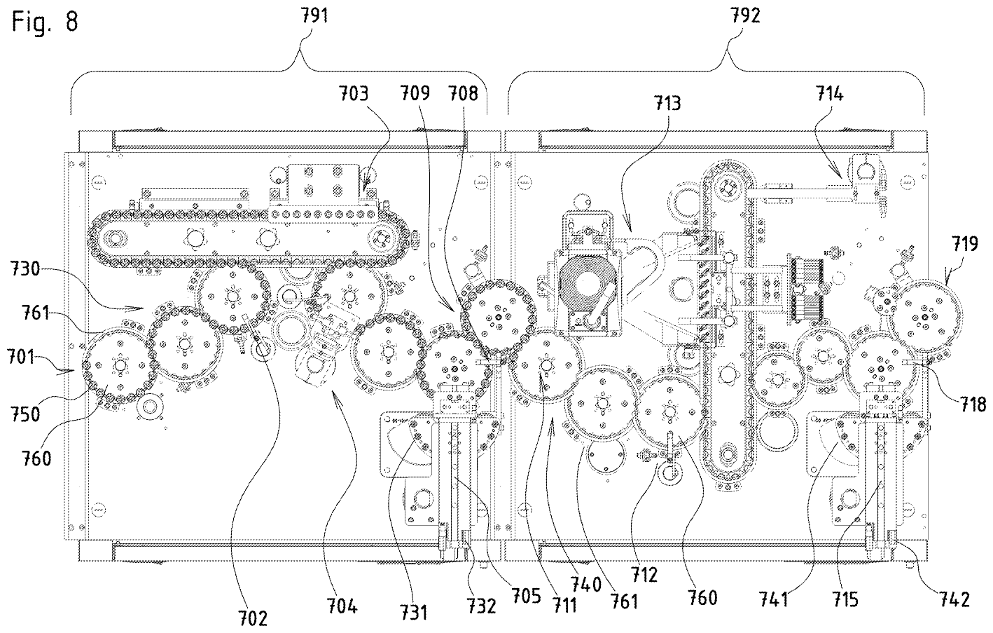

FIGS. 7 and 8 depict a first processing module 791 and a second processing module 792 of a manufacturing line 700 for simulated smoking devices. The manufacturing line 700 may comprise one or more upstream processing modules and one or more downstream processing modules.

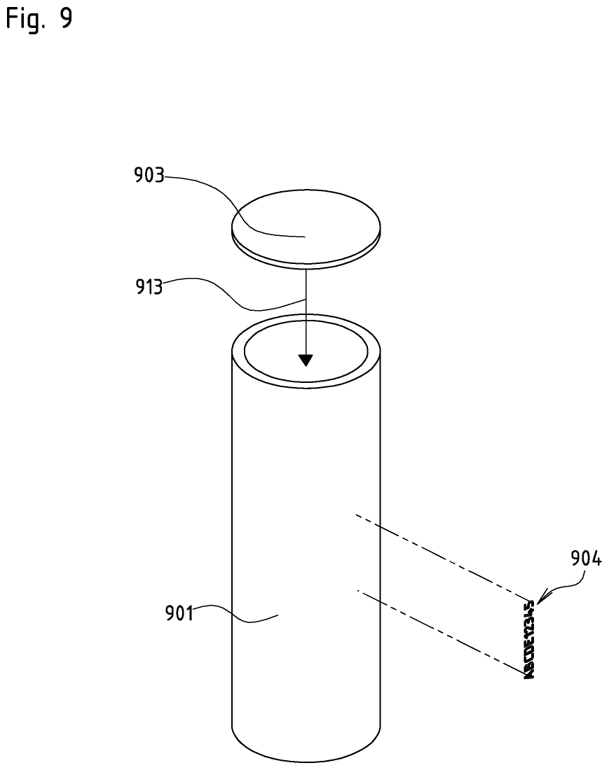

First processing module 791 is configured to perform a processing operation of assembly of a pipe portion 901 and a cap 903, as illustrated in FIG. 9. The cap 903 is to be mounted on an end of the pipe portion 901 as indicated by arrow 913.

Second processing module 792 is configured to apply a marking 904 on the outer surface of the pipe portion 901, as illustrated in FIG. 9. The marking 904 may be provided by a laser engraving.

First processing module 791 comprises a transport receipt interface 701, a first detector 702, a processing station 703, an evaluation station 704, a removal station 705 for defective component removal and for sampling, a second detector 708, a transport delivery interface 709, a controller 710, and a transport device 730. A discharge device 731, such as a container, for rejected components and a discharge device 732, such as a container, for sampled components are provided.

Second processing module 792 comprises a transport receipt interface 711, a first detector 712, a processing station 713, an evaluation station 714, a removal station 715 for defective component removal and for sampling, a second detector 718, a transport delivery interface 719, a controller 720, and a transport device 740. A discharge device 741, such as a container, for rejected components and a discharge device 742, such as a container, for sampled components are provided.

The first and second processing modules 791, 792 each comprise a cabinet 794, 795, respectively, providing mounting space for electric, pneumatic and or hydraulic supply lines, and for control circuitry such as controllers 710, 720. When the cabinets 794, 795 are mechanically coupled to each other, the transport delivery interface 709 of the first processing module 791 engages, i.e. is coupled to, the transport receipt interface 711 of the second processing module 792. From FIG. 8 it can be recognized that it is also possible to couple the transport delivery interface 719 of the second processing module 792 to the transport receipt interface 701 of the first processing module 791 by interchanging the positions of the first processing module 791 and the second processing module 792. Accordingly, the transport receipt interfaces and the transport delivery interfaces of the processing modules are standardized. Thus, other processing modules which also are provided with such standardized transport receipt interfaces and transport delivery interfaces may be coupled to, or inserted between, the first and second processing modules 791, 792.

The transport devices 730 and 740 each comprise rotatably driven disks 760 provided with recesses at their circumference, and combined with guide rims 761, to form product carriers, or to convey separate product carriers 750 each carrying a component.

As explained in detail above, a processing line for performing processing operations on products or parts thereof to be conveyed in the processing line comprises a plurality of processing modules configured to perform different processing operations on the products. The processing line may be a simulated smoking device manufacturing line. Each processing module comprises a transport receipt interface, a transport delivery interface, a transport device to move a product in a product carrier along a transport trajectory from the transport receipt interface to the transport delivery interface, and, along the trajectory, a first detector to detect presence or absence of a product in a product carrier, a processing station to perform a processing operation on a product, an evaluation station to evaluate the result of the processing operation on the product, a removal station to discharge the product from the processing module, and a controller configured to control the operations of the processing station, the evaluation station, and the removal station.

This disclosure pertains to the following clauses:

A processing line for performing processing operations on products or parts thereof to be conveyed in the processing line, wherein the processing line comprises a plurality of processing modules configured to perform different processing operations on the products or parts thereof, each processing module comprising:
a transport receipt interface to receive one of the products or parts thereof supplied to the processing module;
a transport delivery interface to deliver one of the products or parts thereof from the processing module;
a transport device to move one of the products or parts thereof in a product carrier along a transport trajectory from the transport receipt interface to the transport delivery interface, wherein the transport device comprises multiple product carriers;
a first detector arranged at the transport trajectory downstream of the transport receipt interface, wherein the first detector is configured to detect presence or absence of one of the products or parts thereof in one of the product carriers;
a processing station arranged at the transport trajectory downstream of the first detector, wherein the processing station is configured to perform a processing operation on one of the products or parts thereof;
an evaluation station arranged at the transport trajectory downstream of the processing station, wherein the evaluation station is configured to evaluate the result of the processing operation on the one of the products or parts thereof;
a removal station arranged at the transport trajectory downstream of the evaluation station, wherein the removal station is configured to remove one of the products or parts thereof from the corresponding product carrier to discharge the one of the products or parts thereof from the processing module, or to maintain the one of the products or parts thereof in the corresponding product carrier; and
a controller configured to control the operations of the processing station, the evaluation station, and the removal station.

2. The processing line according to clause 1, wherein the controller is configured to:
control the operation of the processing station and the evaluation station based on a detection made by the first detector, wherein, only if the first detector detects a presence of one of the products or parts thereof in one of the product carriers:
   the processing station performs a processing operation on the one of the products or parts thereof in the one of the product carriers, and
   the evaluation station performs an evaluation of the result of the processing operation on the one of the products or parts thereof in the one of the product carriers.

3. The processing line according to any of the preceding clauses, wherein the controller is configured to:
control the operation of the removal station based on an evaluation of one of the products or parts thereof made by the evaluation station, wherein, if the evaluation in the evaluation station indicates that the one of the products or parts thereof in one of the product carriers is to be rejected, the removal station removes the one of the products or parts thereof from the one of the product carriers.

4. The processing line according to any of the preceding clauses, wherein at least one of the processing modules further comprises:
a second detector arranged at the transport trajectory upstream of the transport delivery interface, wherein the second detector is configured to detect a presence or absence of one of the products or parts thereof in one of the product carriers.

5. The processing line according to 4, wherein the controller is configured to:
control the operation of the transport device based on detections made by the first detector and the second detector, and the evaluation made in the evaluation station, wherein:
   if the first detector detects a presence of one of the products or parts thereof in one of the product carriers, and if the evaluation in the evaluation station indicates that the one of the products or parts thereof is to be rejected, and if the second detector detects a presence of the one of the products or parts thereof in the one of the product carriers, an operation of the transport device is stopped; or
   if the first detector detects a presence of one of the products or parts thereof in one of the product carriers, and if the evaluation in the evaluation station indicates that the one of the products or parts thereof is to be approved, and if the second detector detects an absence of the one of the products or parts thereof in the one of the product carriers, an operation of the transport device is stopped.

6. The processing line according to clause 1, wherein the removal station further is configured to remove one of the products or parts thereof from the corresponding product carrier to discharge the one of the products or parts thereof from the processing module for sampling the one of the products or parts thereof.

7. The processing line according to any of clauses 1 to 3, wherein at least one of the processing modules further comprises:
a sampling station arranged at the transport trajectory downstream of the evaluation station, wherein the sampling station is configured to remove one of the products or parts thereof from the corresponding product carrier to discharge the one of the products or parts thereof from the processing module for sampling the one of the products or parts thereof, wherein the controller is further configured to control the sampling station.

8. The processing line according to clause 7, wherein the sampling station is upstream of the removal station, and the controller is configured to:
control the operation of the sampling station based on an evaluation of one of the products or parts thereof made by the evaluation station, wherein, if the evaluation in the evaluation station indicates that the one of the products or parts thereof in one of the product carriers is to be rejected, the sampling station does not remove the one of the products or parts thereof from the one of the product carriers.

9. The processing line according to clause 7, wherein the sampling station is downstream of the removal station, and the controller is configured to:
control the operation of the sampling station based on an evaluation of one of the products or parts thereof made by the evaluation station, wherein, if the evaluation in the evaluation station indicates that the one of the products or parts thereof in one of the product carriers is to be approved, the sampling station is enabled to remove the one of the products or parts thereof from the one of the product carriers.

10. The processing line according to clauses 4 and 7, wherein the controller is configured to:
control the operation of the transport device based on detections made by the first detector and the second detector, and the evaluation made in the evaluation station, wherein:
   if the first detector detects a presence of one of the products or parts thereof in one of the product carriers, and if the evaluation in the evaluation station indicates that the one of the products or parts thereof is to be rejected or the sampling station is controlled to sample the one of the products or parts thereof, and if the second detector detects a presence of the one of the products or parts thereof in the one of the product carriers, an operation of the transport device is stopped; or
   if the first detector detects a presence of one of the products or parts thereof in one of the product carriers, and if the evaluation in the evaluation station indicates that the one of the products or parts thereof is to be approved or the sampling station is controlled not to sample the one of the products or parts thereof, and if the second detector detects an absence of the one of the products or parts thereof in the one of the product carriers, an operation of the transport device is stopped.

11. The processing line according to any of the preceding clauses, wherein the controller further is configured to communicate with a further controller of a further processing module to control at least the transport device of the further processing module.

12. The processing line according to any of the preceding clauses, wherein the transport receipt interface of at least one of the processing modules is configured to be directly coupled to a transport delivery interface of a preceding processing module.

13. The processing line according to any of the preceding clauses, wherein the transport delivery interface of at least one of the processing modules is configured to be directly coupled to a transport receipt interface of a succeeding processing module.

14. Simulated smoking device manufacturing line for performing processing operations on components of simulated smoking devices to be conveyed in the manufacturing line, wherein the simulated smoking device manufacturing line comprises a plurality of processing modules configured to perform different processing operations on the components, each processing module comprising:
a transport receipt interface to receive one of the components supplied to the processing module;
a transport delivery interface to deliver one of the components from the processing module;
a transport device to move one of the components in a product carrier along a transport trajectory from the transport receipt interface to the transport delivery interface, wherein the transport device comprises multiple product carriers;
a first detector arranged at the transport trajectory downstream of the transport receipt interface, wherein the first detector is configured to detect presence or absence of one of the components in one of the product carriers;
a processing station arranged at the transport trajectory downstream of the first detector, wherein the processing station is configured to perform a processing operation on one of the components;
an evaluation station arranged at the transport trajectory downstream of the processing station, wherein the evaluation station is configured to evaluate the result of the processing operation on the one of the components;
a removal station arranged at the transport trajectory downstream of the evaluation station, wherein the removal station is configured to remove one of the components from the corresponding product carrier to discharge the one of the components from the processing module, or to maintain the one of the components in the corresponding product carrier; and
a controller configured to control the operations of the processing station, the evaluation station, and the removal station.

As required, detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a”/“an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

1. A processing line for performing processing operations on products or parts thereof to be conveyed in the processing line, wherein the processing line comprises a plurality of processing modules configured to perform different processing operations on the products or parts thereof, each processing module comprising:
a transport receipt interface to receive one of the products or parts thereof supplied to the processing module;
a transport delivery interface to deliver one of the products or parts thereof from the processing module;
a transport device to move one of the products or parts thereof in a product carrier along a transport trajectory from the transport receipt interface to the transport delivery interface, wherein the transport device comprises multiple product carriers;
a first detector arranged at the transport trajectory downstream of the transport receipt interface, wherein the first detector is configured to detect presence or absence of one of the products or parts thereof in one of the product carriers;
a processing station arranged at the transport trajectory downstream of the first detector, wherein the processing station is configured to perform a processing operation on one of the products or parts thereof;
an evaluation station arranged at the transport trajectory downstream of the processing station, wherein the evaluation station is configured to evaluate the result of the processing operation on the one of the products or parts thereof;
a removal station arranged at the transport trajectory downstream of the evaluation station, wherein the removal station is configured to remove one of the products or parts thereof from the corresponding product carrier to discharge the one of the products or parts thereof from the processing module, and to otherwise maintain the one of the products or parts thereof in the corresponding product carrier; and
a controller configured to control the operations of the processing station, the evaluation station, and the removal station.

2. The processing line according to claim 1, wherein the processing module is configured to deliver one of the products or parts thereof to the transport delivery interface if the evaluation of the one of the products or parts thereof by the evaluation station of the processing module indicates that the processing operation in the processing station of the processing module has been performed correctly, and to remove one of the products or parts thereof from the processing module via the removal station and not deliver the one of the products or parts thereof at the transport delivery interface of the processing module if the evaluation of the one of the products or parts thereof by the evaluation station of the processing module indicates that the processing operation in the processing station of the processing module has not been performed correctly.

3. The processing line according to claim 1, wherein the evaluation station is configured to evaluate if the processing operation in the processing station of the processing module has been performed correctly.

4. The processing line according to claim 1, wherein the controller is configured to:
control the operation of the processing station and the evaluation station based on a detection made by the first detector, wherein, only if the first detector detects a presence of one of the products or parts thereof in one of the product carriers:
the processing station performs a processing operation on the one of the products or parts thereof in the one of the product carriers, and
the evaluation station performs an evaluation of the result of the processing operation on the one of the products or parts thereof in the one of the product carriers.

5. The processing line according to claim 1, wherein the controller is configured to:
control the operation of the removal station based on an evaluation of one of the products or parts thereof made by the evaluation station, wherein, if the evaluation in the evaluation station indicates that the one of the products or parts thereof in one of the product carriers is to be rejected, the removal station removes the one of the products or parts thereof from the one of the product carriers.

6. The processing line according to claim 1, wherein at least one of the processing modules further comprises:
a second detector arranged at the transport trajectory upstream of the transport delivery interface, wherein the second detector is configured to detect a presence or absence of one of the products or parts thereof in one of the product carriers.

7. The processing line according to claim 6, wherein the controller is configured to:
control the operation of the transport device based on detections made by the first detector and the second detector, and the evaluation made in the evaluation station, wherein:
if the first detector detects a presence of one of the products or parts thereof in one of the product carriers, and if the evaluation in the evaluation station indicates that the one of the products or parts thereof is to be rejected, and if the second detector detects a presence of the one of the products or parts thereof in the one of the product carriers, an operation of the transport device is stopped; or
if the first detector detects a presence of one of the products or parts thereof in one of the product carriers, and if the evaluation in the evaluation station indicates that the one of the products or parts thereof is to be approved, and if the second detector detects an absence of the one of the products or parts thereof in the one of the product carriers, an operation of the transport device is stopped.

8. The processing line according to claim 1, wherein the removal station further is configured to remove one of the products or parts thereof from the corresponding product carrier to discharge the one of the products or parts thereof from the processing module for sampling the one of the products or parts thereof.

9. The processing line according to claim 1, wherein at least one of the processing modules further comprises:
a sampling station arranged at the transport trajectory downstream of the evaluation station, wherein the sampling station is configured to remove one of the products or parts thereof from the corresponding product carrier to discharge the one of the products or parts thereof from the processing module for sampling the one of the products or parts thereof,
wherein the controller is further configured to control the sampling station.

10. The processing line according to claim 9, wherein the sampling station is upstream of the removal station, and the controller is configured to:
control the operation of the sampling station based on an evaluation of one of the products or parts thereof made by the evaluation station, wherein, if the evaluation in the evaluation station indicates that the one of the products or parts thereof in one of the product carriers is to be rejected, the sampling station does not remove the one of the products or parts thereof from the one of the product carriers.

11. The processing line according to claim 9, wherein the sampling station is downstream of the removal station, and the controller is configured to:
control the operation of the sampling station based on an evaluation of one of the products or parts thereof made by the evaluation station, wherein, if the evaluation in the evaluation station indicates that the one of the products or parts thereof in one of the product carriers is to be approved, the sampling station is enabled to remove the one of the products or parts thereof from the one of the product carriers.

12. The processing line according to claim 1,
wherein at least one of the processing modules further comprises:
a second detector arranged at the transport trajectory upstream of the transport delivery interface, wherein the second detector is configured to detect a presence or absence of one of the products or parts thereof in one of the product carriers;
wherein at least one of the processing modules further comprises:
a sampling station arranged at the transport trajectory downstream of the evaluation station, wherein the sampling station is configured to remove one of the products or parts thereof from the corresponding product carrier to discharge the one of the products or parts thereof from the processing module for sampling the one of the products or parts thereof;
wherein the controller is further configured to control the sampling station; and
wherein the controller is further configured to:
control the operation of the transport device based on detections made by the first detector and the second detector, and the evaluation made in the evaluation station, wherein:
if the first detector detects a presence of one of the products or parts thereof in one of the product carriers, and if the evaluation in the evaluation station indicates that the one of the products or parts thereof is to be rejected or the sampling station is controlled to sample the one of the products or parts thereof, and if the second detector detects a presence of the one of the products or parts thereof in the one of the product carriers, an operation of the transport device is stopped; or
if the first detector detects a presence of one of the products or parts thereof in one of the product carriers, and if the evaluation in the evaluation station indicates that the one of the products or parts thereof is to be approved or the sampling station is controlled not to sample the one of the products or parts thereof, and if the second detector detects an absence of the one of the products or parts thereof in the one of the product carriers, an operation of the transport device is stopped.

13. The processing line according to claim 1, wherein the controller further is configured to communicate with a further controller of a further processing module to control at least the transport device of the further processing module.

14. The processing line according to claim 1, wherein the transport receipt interface of at least one of the processing modules is configured to be directly coupled to a transport delivery interface of a preceding processing module.

15. The processing line according to claim 1, wherein the transport delivery interface of at least one of the processing modules is configured to be directly coupled to a transport receipt interface of a succeeding processing module.

16. A simulated smoking device manufacturing line for performing processing operations on components of simulated smoking devices to be conveyed in the manufacturing line, wherein the simulated smoking device manufacturing line comprises a plurality of processing modules configured to perform different processing operations on the components, each processing module comprising:
a transport receipt interface to receive one of the components supplied to the processing module;
a transport delivery interface to deliver one of the components from the processing module;
a transport device to move one of the components in a product carrier along a transport trajectory from the transport receipt interface to the transport delivery interface, wherein the transport device comprises multiple product carriers;
a first detector arranged at the transport trajectory downstream of the transport receipt interface, wherein the first detector is configured to detect presence or absence of one of the components in one of the product carriers;
a processing station arranged at the transport trajectory downstream of the first detector, wherein the processing station is configured to perform a processing operation on one of the components;
an evaluation station arranged at the transport trajectory downstream of the processing station, wherein the evaluation station is configured to evaluate the result of the processing operation on the one of the components;
a removal station arranged at the transport trajectory downstream of the evaluation station, wherein the removal station is configured to remove one of the components from the corresponding product carrier to discharge the one of the components from the processing module, and to otherwise maintain the one of the components in the corresponding product carrier; and
a controller configured to control the operations of the processing station, the evaluation station, and the removal station.
